(19) United States
(12) Patent Application Publication
(10) Pub. No.: US 2003/0185018 A1
(43) Pub. Date: Oct. 2, 2003

(54) Stroller light

(76) Inventor: C. Comrada (Catherine), Los Gatos, CA (US)

Correspondence Address: Catherine Comrada, 15559 Union Avenue # 201, Los Gatos, CA, 95032, US

(21) Appl. No.: 10/096,970

(22) Filed: Mar. 14, 2002

(51) Int. Cl. F21V 21/088; F21L 4/02

(52) U.S. Cl. 362/544; 362/191; 362/251; 362/396; 362/234

(57) ABSTRACT

Stroller Light with an enclosure having a circular front panel, integral side walls and an attached back panel, the flat front panel having a plurality of lighting elements spaced about its perimeter, the front panel also having a photo voltaic cell for charging a power supply that is inside the enclosure, the enclosure containing a power supply such as a battery and a micro processor circuit that causes the lights to flash, an on-off switch accessible on the outside of said enclosure to cause said lights to turn on or off, a plurality securing means attached to said back panel, said securing means including a spring biased clip, a first stroller attaching portion and a flag pole holder. A preferred embodiment includes further comprising a second stroller attaching portion that can attach to the frame structure of said stroller by means of a hose clamp type connector, said second stroller attaching portion having a standard means of attachment that allows said second stroller attaching portion to removably and replaceably attach to said first stroller attaching portion.

### BACKGROUND OF THE INVENTION

This invention relates generally to the field of portable lights, and more particularly to a baby stroller Light.

Various types of safety lights that can be attached to a person's clothes or bicycle or the like are known and are available in the market place.

Recently, the use of flashing LED type lights has become popular and have been designed to attach to a person's clothing or body part, or attached to a bicycle. However, none of the present designs effectively addresses the application of a safety light that can easily attach to the frame of a baby stroller. Additionally, the present designs do not allow for the safety light to be able to be attached securely yet easily removed. Also, the present designs do not have the ability to also include the attachment of a flagpole and flag. The present designs also do not have the ability to have various integral attachment means that allows the user to fasten the device to a stroller or to one's clothing or to a body strap that is worn over clothing. Finally, the prior art does not include the ability to recharge the power supply by use of a photo voltaic cell.

### SUMMARY OF THE INVENTION

The primary object of the invention is to provide a light for a baby stroller so it can be seen at night by drivers of vehicles, bicycles or the like.

Another object of the invention is to provide a light for a baby stroller that can be easily attached to a variety of different stroller designs.

Another object of the invention is to provide a light for a baby stroller that includes a means to attach a flag pole and attached flag.

A further object of the invention is to provide a light for a baby stroller that can also be clipped onto a person's clothing or wearable strap.

Yet another object of the invention is to provide a light for a baby stroller that includes a photo voltaic cell so that the power supply can be recharged during daylight hours.

Still yet another object of the invention is to provide a light fro a baby stroller that also includes a reflective element that responds brightly when a vehicles headlights strike the reflector.

Other objects and advantages of the present invention will become apparent from the following descriptions, taken in connection with the accompanying drawings, wherein, by way of illustration and example, an embodiment of the present invention is disclosed.

Stroller Light comprising: an enclosure having a circular front panel, integral side walls and an attached back panel, said flat front panel having a plurality of lighting elements spaced about its perimeter, said front panel also having a photo voltaic cell for charging a power supply that is inside said enclosure, said enclosure containing a power supply such as a battery and a micro processor circuit that causes said lights to flash, an on-off switch accessible on the outside of said enclosure to cause said lights to turn on or off, a plurality securing means attached to said back panel, said securing means including a spring biased clip, a first stroller attaching portion and a flag pole holder.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a perspective veil of the stroller light of the present invention shown attached to a stroller

FIG. 2 is a side section view of the present invention

FIG. 3 is a perspective view of the rear of the present invention

FIG. 4 is a perspective view of the first stroller attachment means

FIG. 5 is a perspective view of the first stroller means attached to the frame of a stroller

FIG. 6 is a front view of a person wearing a strap assembly that supports the light of the present invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

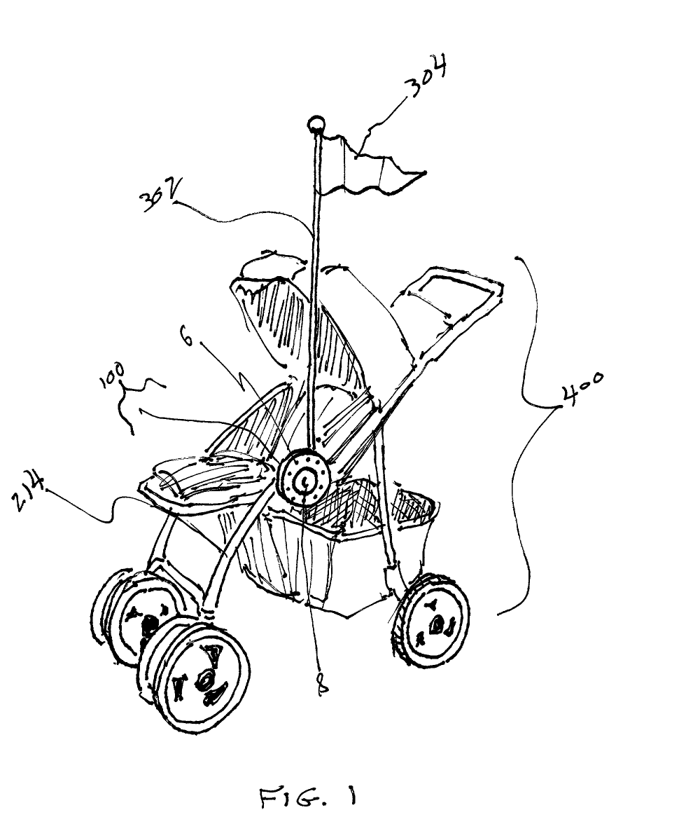

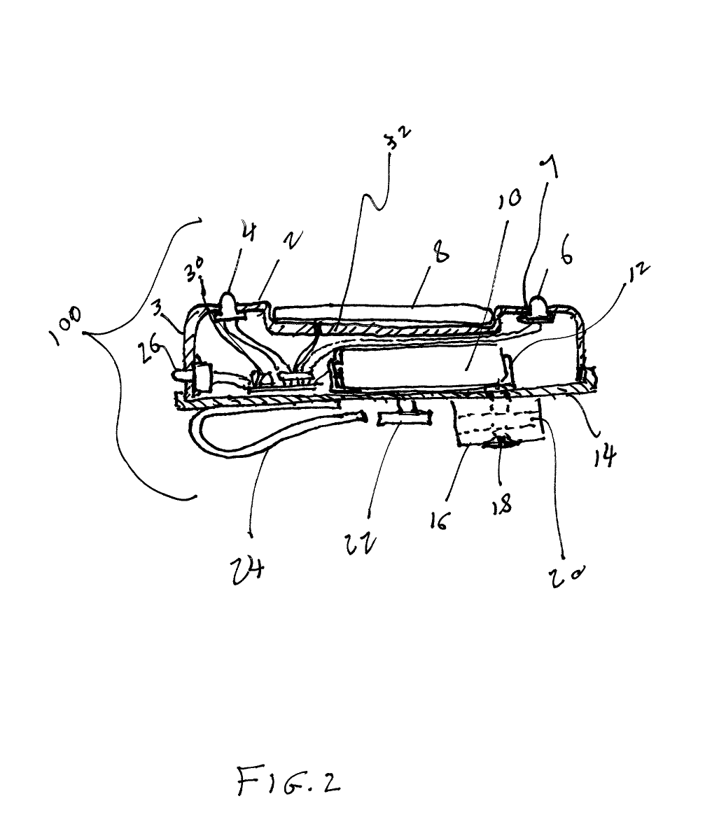

Now to FIG. 1 we see a perspective view of the stroller light of the present invention 100 attached to the frame 214 a standard baby stroller 400. The device 100 has a plurality of lights 6 that flash and thereby warn vehicles and the like that the stroller is present. The center disk 8 is a photo voltaic cell that can recharge the battery located inside the device 100. In an alternate embodiment the photo voltaic cell 8 is replaced by a reflector element that can further warn oncoming vehicles when the vehicle's headlight causes the reflector to glow. The back panel of device 100 has a means to retain a flagpole 302 and attached flag 304 as will be described in later views. FIG. 2 shows a side section view of the stroller light of the present invention 100. The device 100 is comprised of an enclosure which is formed by top plate 2, integral side wall 3 and back panel 14. LED's 6 protrude through apertures 7 in cover plate 2. The fit between the LED 6 and the aperture 7 is tight enough to be water resistant. A depression 32 at the center of the top plate 2 accommodates a photo voltaic cell 8, or in an alternate embodiment, a reflector element. On-off switch 26 turns the lights 6 on or off. Microprocessor circuit 30 helps produce a flashing pattern in LED's. In the preferred embodiment one of 5 different flashing patterns is activated each time the unit is turned on. Battery 10 powers LED's 6 and microprocessor circuit 30. Back panel 14 includes a spring biased clip 24 and a first attachment means 22 as well as a flagpole attachment means 16. The flagpole attachment means 16 includes a pole holding socket 20 and a retaining screw 18 that screws into threaded portion 12 in back plate 14. The screw 18 can be loosened and the pole retaining disk rotated so that the pole is in an upright position regardless of the angle of attachment of the device 100 to the stroller frame 214.

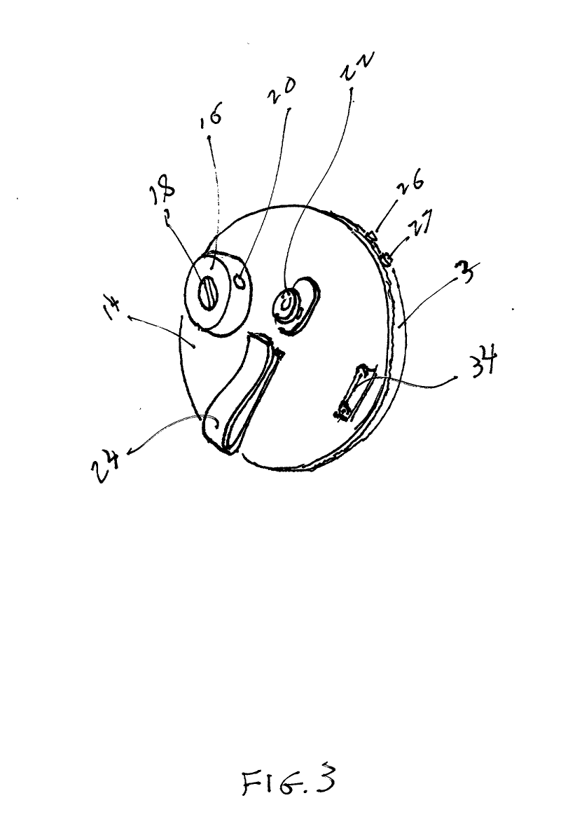

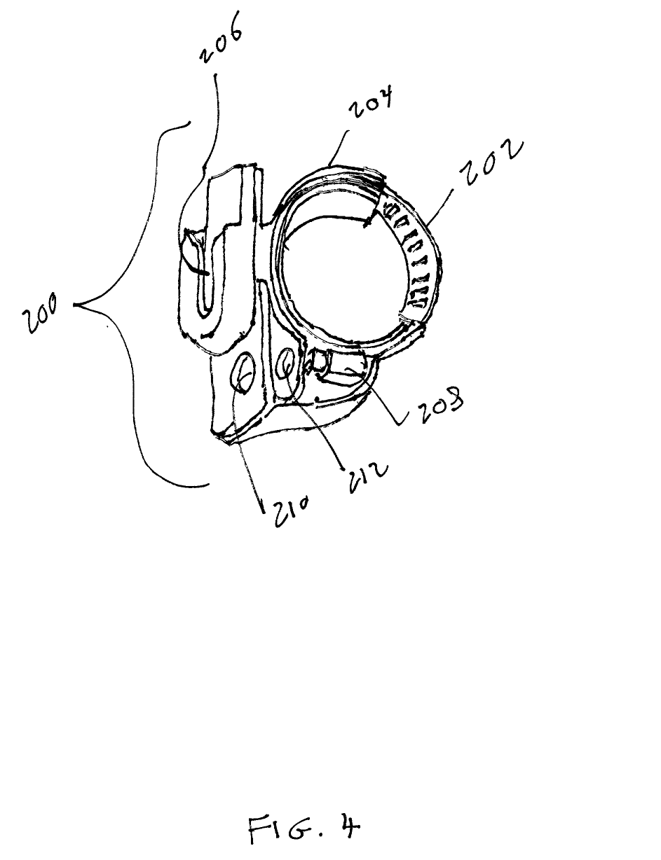

FIG. 3 shows clearer view of the back panel 14. In this view flagpole holder 16 can be more clearly seen along with pole socket 20 and retaining screw 18. Spring clip 24 is shown as well as on-off switch 26. A standard pin clasp is also provided for pinning the device 100 onto a person's clothing. First attachment means 22 is design to mate with second attachment assembly 200 as shown in FIG. 4. The disk shape of first attachment means 22 slides into the groove 206 of second attachment assembly 200. Because the disk of the first attachment means is circular, the entire device 100 can be rotated as needed after attachment to stroller frame 214. The fit between the disk 22 and the groove 206 is a friction fit to reduce the chance of the device 100 falling off of the second attachment assembly 200. A standard hose clamp device 202 is retained within the walls 204 of the assembly 200. The user can unscrew threaded portion 208 by inserting a screw driver through holes 210, 212 until one end of the clamp becomes free. The user can then wrap the clamp strip around a desired spot on the stroller frame 214. The user then tightens the clamp so that the assembly 200 is firmly mounted to the frame 214, even if the frame member is not round in cross section.

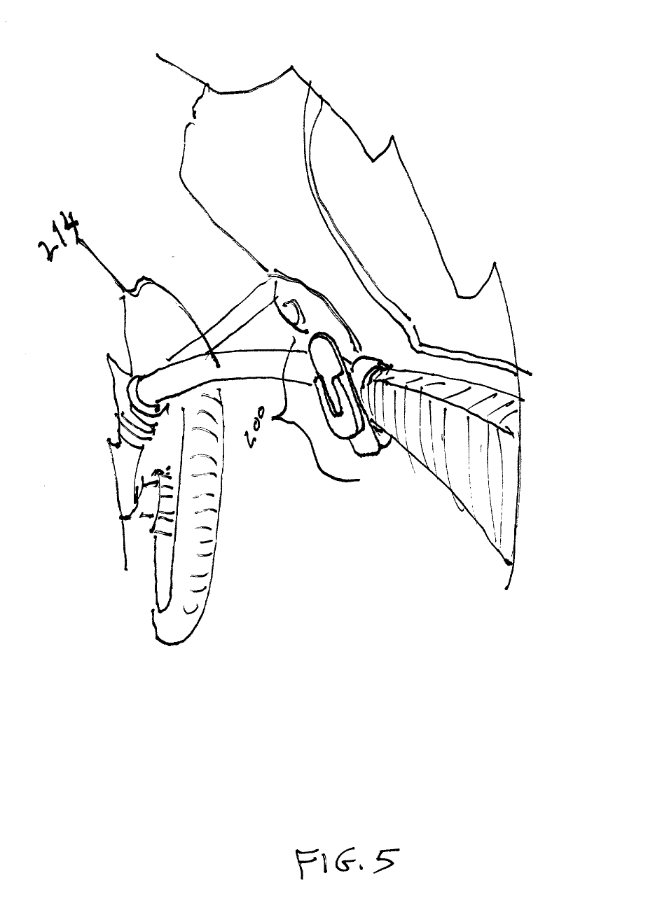

FIG. 5 shows the second attachment assembly 200 in place on a stroller frame 214.

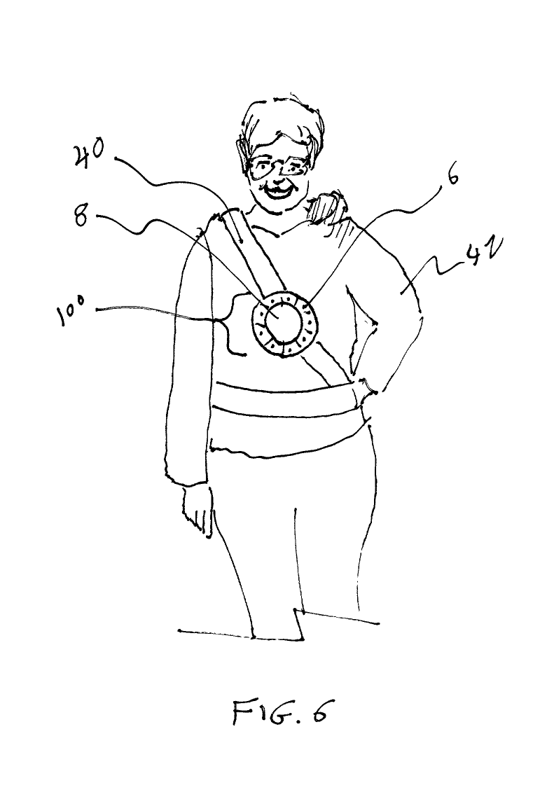

FIG. 6 shows a person wearing the stroller light 100 on a strap assembly 40 that can be worn over the user's clothing 42. The device attaches to the strap 40 by clip 24. LED's 6 can be seen from a distance of several hundred feet. Insert 8 is photo voltaic cell in the preferred embodiment and a reflector element in an alternate embodiment.

The above illustrations and descriptions show that the stroller light present invention is convenient to use in that it can be easily attached to a stroller frame as well as attached to the user's clothing or a strap worn over the user's clothing. The fact that the main unit 100 can be removed from the second attachment means 200 lets the user take the device 100 off the stroller and use it for other applications when so desired.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Stroller Light comprising:
an enclosure having a circular front panel, integral side walls and an attached back panel;
said flat front panel having a plurality of lighting elements spaced about its perimeter;
said front panel also having a photo voltaic cell for charging a power supply that is inside said enclosure;
said enclosure containing a power supply such as a battery and a micro processor circuit that causes said lights to flash;
an on-off switch accessible on the outside of said enclosure to cause said lights to turn on or off;
a plurality securing means attached to said back panel;
said securing means including a spring biased clip, a first stroller attaching portion and a flag pole holder.

2. Stroller Light as claimed in claim 1 further comprising a second stroller attaching portion that can attach to the frame structure of said stroller by means of a hose clamp type connector, said second stroller attaching portion having a standard means of attachment that allows said second stroller attaching portion to removably and replaceably attach to said first stroller attaching portion.

3. An alternate embodiment of said Stroller Light as claimed in claim 1 wherein said photo voltaic cell is replaced by a reflective panel.

4. Stroller Light as claimed in claim ad wherein said enclosure is water resistant.
